(19) United States
(12) Patent Application Publication
(10) Pub. No.: US 2025/0121901 A1
(43) Pub. Date: Apr. 17, 2025

(54) Bicycle Frame for a Transmission

(71) Applicant: myStromer AG, Oberwangen (CH)

(72) Inventors: Peter Egli, Münchenbuchsee (CH); Dominic Sahli, Bühl (CH)

(21) Appl. No.: 18/684,658

(22) PCT Filed: Jul. 8, 2022
(86) PCT No.: PCT/IB2022/056317

§ 371 Date: Feb. 16, 2024

(30) Foreign Application Priority Data
Aug. 18, 2021 (CH) 070177/2021

(51) Int. Cl. B62J 43/13; B62J 43/28; B62K 19/30; B62M 6/55

(52) U.S. Cl. CPC B62J 43/13; B62J 43/28; B62K 19/30; B62M 6/55

(57) ABSTRACT

The present invention relates to a bicycle frame (2), more particularly for an e-bike (1), comprising: a first frame portion (10) having an interior (12) for receiving at least one battery unit (3); a second frame portion (20), which is connected to the first frame portion (10) and runs to a rear-wheel holder (5); and a receiving region (30) for a transmission unit (40), the receiving region being associated with the frame portion (10); wherein the first frame portion (10), the second frame portion (20) and the receiving region (30) are designed such that cables (50) run substantially within the first frame portion (10) and the second frame portion (20) and only cables used to connect the transmission unit (40) are led into the receiving region (30).

The present invention relates to a bicycle frame, in particular for an E-bike.

The invention further relates to an electric bicycle, all according to the preambles of the independent claims.

### TECHNOLOGICAL BACKGROUND

Bicycles having an electric auxiliary motor are becoming more and more popular, since to a great extent they meet the increasing demand for reliable, safe, and sustainable mobility. An electric bicycle is a bicycle that is assisted by an electric motor during pedaling, thus making the pedaling easier. The motor assists with the pedaling movements, reinforcing or completely taking over same. This type of electric bicycle is also referred to as an E-bike, pedelec, or speed pedelec. There are various types, which differ according to the application, motor power, frame, or profile of the tires.

A bicycle frame for accommodating a battery unit and an accompanying battery unit is known from the prior art, for example from EP 2230164 B1. The frame has a tube section with an interior space that accommodates a battery unit. A lateral opening extends in the direction of the extension of the tube section. The battery unit is inserted into the interior space through the lateral opening. An arrangement of the battery in the tube section has advantages.

An E-bike bicycle frame having a top tube, a down tube, and a seat tube is known from EP 3437977 A1. In addition, a bottom bracket is situated in a housing, which may be a bottom bracket receiving element. The electric motor is optionally also provided in the housing. In addition, a battery is connected to the down tube. The arrangement of the battery on the down tube has the disadvantage that laying cables, hydraulic lines, and in particular shifter cables such as Bowden cables, is difficult. A channel element is therefore situated to the side of the battery. The channel element is used to accommodate cables, shifter cables, brake cables, and/or hydraulic lines. The bottom bracket is situated in a bottom bracket receptacle and is connected to an electric motor.

In particular for shifter cables, it is necessary to lay them with the smallest possible radii; damage may occur with narrow radii. In particular, the wear is increased, and the functional reliability may possibly not be ensured.

In bicycles the gear ratio is important. In addition to derailleurs, gearshifts with a transmission are also becoming increasingly prevalent in electric bicycles, where gearwheels engage with one another and thus provide a gear ratio. Gearwheels having different numbers of teeth are brought into contact by tightening or relaxing a gearshift cable. Electric or electronic gearshifts are operated by means of a battery or a rechargeable battery.

There is a large variety of gearshifts and model variants. The gearshift is an important component of an E-bike, and is designed to be easy to operate, with low maintenance. Besides derailleurs, hub gear systems are known, which are usually integrated into the rear hub.

Bottom bracket transmissions, for example from Pinion, are a further category of gearshifts. Bottom bracket transmissions have a plurality of gears with a large gear ratio range, and are generally low-maintenance.

Hub gear systems and bottom bracket transmissions have the advantage that they may be combined with belts, which reduces the maintenance effort.

The housing of a bottom bracket transmission may be connected to the frame, and is generally flange-mounted to the frame from the bottom. The frame thereby corresponds approximately to the width of the housing. The supply cables are guided into the housing in a manner that is visible from the outside.

### DESCRIPTION OF THE INVENTION

Thus, it is an object of the present invention to provide a bicycle frame of the type mentioned at the outset, which overcomes at least one disadvantage of the known.

In particular, a bicycle frame having an integrated transmission for an E-bike is provided, which has a high level of acceptance with users with regard to functionality and usability. The stated bicycle frame having the integrated transmission is preferably intended to be as safe as possible during operation and also particularly easy to maintain, and to provide sufficient space for cable routing.

At least one of these objects has been achieved using a bicycle frame, in particular for an E-bike, according to the features of the independent claim.

One aspect of the present invention relates to a bicycle frame, in particular for an E-bike. The bicycle frame includes a first frame section having an interior space for accommodating at least one battery unit, a second frame section that adjoins the first frame section and extends to a rear wheel receptacle, and a receiving region, associated with the frame section, for a transmission unit. The first frame section, the second frame section, and the receiving region are designed in such a way that cables extend essentially inside the first frame section and the second frame section, and essentially only cables that are used to connect the transmission unit are guided into the receiving region.

Due to the design of the frame, the transmission unit may be integrated into the frame, and there is still enough space for cable routing. As a result of the concealed mounting, a wide variety of transmission units may be installed without the type of transmission being visible from the outside. In addition, the transmission is largely protected from external influences or damage.

The frame essentially encloses the transmission unit, and thus protects the transmission unit. In one embodiment, the transmission unit is practically completely enclosed or covered. In one particular embodiment, the transmission unit is completely enclosed and covered, so that the transmission unit is not visible from the outside.

The cables to be guided may comprise an electric cable, a shifter cable, a brake cable, and/or a hydraulic line. It is advantageous that even further cables may be guided in the frame.

In one preferred embodiment, the receiving region has an at least semicircular or arched recess or opening on both sides. This imparts better stability to the frame. In addition, simple installation of the transmission unit is possible. In one particular embodiment, the receiving region is adapted to the contour of the transmission. The transmission or the transmission unit is thus integrated into the frame, and is thus also better protected. It is particularly advantageous that, due to the concealed mounting, a wide variety of transmissions or transmission units may be installed, and also replaced, without being visible from the outside. A different or special shape may thus be imparted to the frame.

Although the transmission unit is integrated into the frame, the frame construction provides sufficient stability and also adequate space for cables. In addition, the E-bike having an integrated transmission is particularly easy to maintain, since all necessary or required access is ensured.

The present mechanical integration may be assisted or supplemented with electric integration. The transmission of the E-bike is controllable by a certain “intelligence.” This may take place using a data cable that is guided with protection inside the frame, or using a wireless approach. Based on user behavior, the route traveled, and/or the battery status, for example optimal assistance or gear shifting may be determined and implemented by computer.

It is particularly advantageous when the receiving region has a flat surface in the interior. This allows the provision of a base plate, which may be well anchored or welded inside the frame. Fastening elements that securely hold the transmission unit may be provided at the base plate. Thus, no weld seams are visible from the outside. The transmission unit may rest against the base plate or be fastened thereto. High stability may thus be ensured, even under high load on the pedals.

The receiving region advantageously includes a feedthrough region for guiding the cables. This has the advantage that the passage is accessible from the outside when the transmission is uninstalled or is being uninstalled. Without such “simple” access, it is often very time-consuming to guide lines and cables, i.e., from the first to the second frame section or vice versa, for installation and service.

The installation of the transmission unit may take place using screw connections. The cable connections are established inside the receiving region. In one preferred embodiment, the receiving region is provided with a decorative panel on the outside.

When the receiving region for the transmission unit is situated essentially at one end of the first frame section, at the transition to the second frame section, as a result of the frame geometry it may be ensured that loads from a drive belt or due to pedaling force are tolerable by the frame.

In a further preferred embodiment, the second frame section directly adjoins the first frame section, so that no interruptions occur. Thus, no additional connections are necessary, but the necessary strength and functionality are provided.

The second frame section preferably has a fork-shaped design after a seat tube, so that a rear wheel may be fastened and supported at the end. The second frame section extends to the rear end, which likewise is connected to the seat stay.

When the first frame section, the receiving region, and the second frame section merge seamlessly into one another, this results in an overall stable frame shape which also withstands heavy loads.

In one preferred embodiment, the first frame section, the receiving region, and the second frame section have a cable routing region in the interior. It is particularly advantageous that the cable routing region has a continuous design. Cables may thus be guided internally to the rear wheel axle. Mechanical damage from the outside may thus be largely excluded and prevented.

A further aspect of the present invention relates to an electric bicycle that includes a bicycle frame according to the invention.

Within the meaning of the present invention, the bicycle frame includes all components and parts that are necessary for safe operation of an electric bicycle.

It is particularly preferred to design the bicycle frame in such a way that a stable frame results that meets the requirements of a recent E-bike.

For the person skilled in the art, it is self-evident that all preferred and special embodiments described may be implemented in any given combination in a design according to the invention, provided that they are not mutually exclusive.

The present invention is now explained in greater detail below based on specific exemplary embodiments and figures, but without being limited to same. For the person skilled in the art, further advantageous embodiments arise from the study of these specific exemplary embodiments. For the sake of simplicity, identical parts are provided with the same reference numerals in the figures.

### DESCRIPTION OF THE FIGURES

Exemplary embodiments of the invention are described based on the following figures. The figures, which are not true to scale, show the following:

FIG. 1 shows a right side view of an E-bike with a bicycle frame according to the invention;

FIG. 2 shows a left side view of an E-bike with a bicycle frame according to the invention;

FIG. 3 shows a bicycle frame according to the invention without accessory parts;

FIG. 4 shows a bicycle frame according to the invention with a schematic illustration of the cable routing region;

FIG. 5a shows a depiction of the receiving region from below;

FIG. 5b shows a further illustration of a receiving region;

FIG. 6 shows a further side view of an E-bike with a bicycle frame according to the invention, including a decorative panel;

FIG. 7 shows a further side view of an E-bike with a bicycle frame according to the invention; and

FIG. 8 shows a detailed view of the transmission installation, including the decorative panel.

### EMBODIMENT OF THE INVENTION

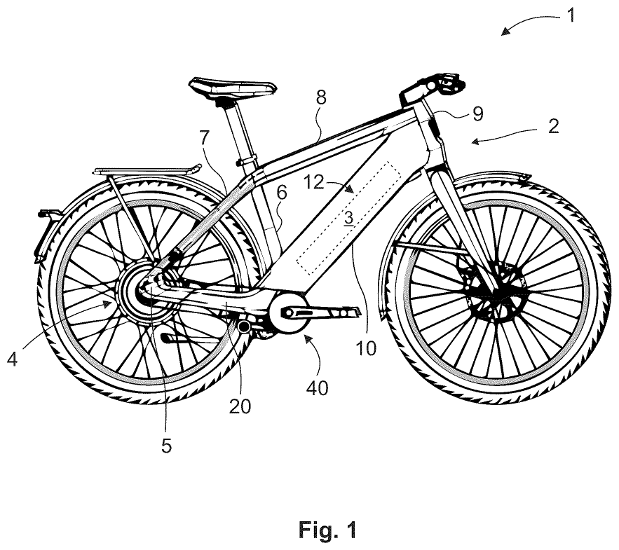

FIG. 1 illustrates a right side view of a bicycle 1 that is driven by an electric motor. The bicycle 1, also referred to as an E-bike, includes a bicycle frame 2. The bicycle frame 2 has a first frame section 10, and a second frame section 20 that adjoins the first frame section 10 and extends to a rear wheel suspension or rear wheel receptacle 5. The first frame section 10 has an interior space 12 for accommodating a battery unit 3, which is schematically illustrated in FIG. 1. The battery unit 3 delivers the energy for an electric motor 4 situated at the rear wheel. Such an electric motor 4 may be used as a complete bicycle drive and also as a hybrid drive, in which the muscular power by the bicycle rider is assisted as a function of the drive force that is transferred by the pedal drive to the rear wheel. A drive unit that is designed as a chain or belt extends from the front pinion to the rear pinion.

The frame construction is made up essentially of a seat tube 6, a top tube 8, and the first frame section 10, which are arranged in a triangular shape, a head tube 9 on the front side, two seat tube stays 7 situated in each case on the rear side, and the second frame section 20, which directly adjoins the first frame section 10 and is guided to the rear wheel suspension 5 by rear wheel stays.

The first frame section 10 has a cross-sectional shape that is elongated in the plane of the frame, compared to the seat tube 6 and the top tube 8, so that an enlarged frame cross section is created.

A transmission unit 40 is provided in a receiving region at the lower end of the first frame section 10 (more easily visible in the subsequent figures), the transmission unit 40 as such being integrated into the bicycle frame 2. A derailleur is dispensed with on account of the transmission unit 40. The transmission unit 40 steps up or steps down the rider's power, for example on the belt. The transmission unit 40 and the pedal axis are close together. The transmission unit 40 and the bottom bracket together with the pedals are situated at the correct or most suitable location with regard to the center of gravity.

Due to the frame according to the invention, cables such as electric cables, a shifter cable, a brake cable, or hydraulic lines may advantageously extend essentially inside the first frame section 10 and the second frame section 20.

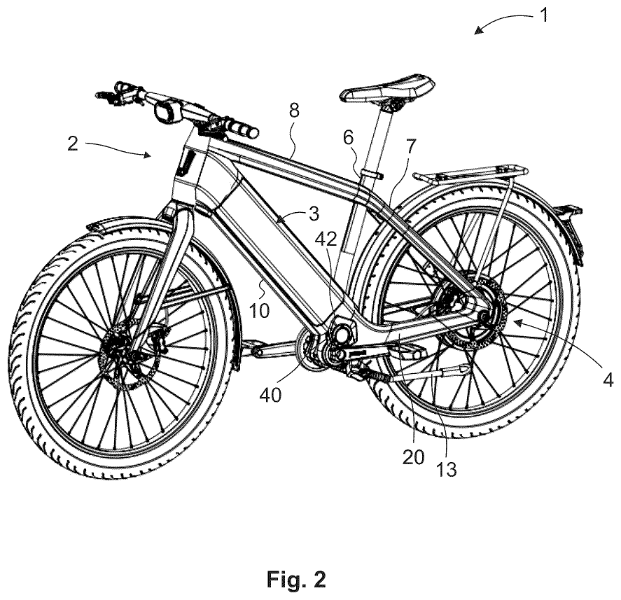

FIG. 2 shows a left side view of the E-bike 1 with the bicycle frame 2 according to the invention. The bicycle frame 2 has the first frame section 10, and the second frame section 20 which adjoins the first frame section 10 and extends to the rear wheel suspension. The first frame section 10 contains the battery unit 3. The electric motor 4 is situated at the rear wheel.

The bicycle frame 2 once again is made up essentially of the seat tube 6, the top tube 8, and the first frame section 10, as well as the two seat tube stays 7 situated in each case on the rear side, and the second frame section 20.

The E-bike 1, as illustrated in FIGS. 1 and 2, also includes a front wheel and a rear wheel, handlebars with grips and a gearshift, a seat that is connected to the seat tube 6, an optional carrier, a kickstand 13 or stand for short, brakes, and lights.

The transmission unit 40 is clearly visible in the left side view. It is directly adjoined by the bottom bracket with the pedals. The transmission unit 40 is situated in a receiving region of the bicycle frame 2 and is covered by a decorative panel 42. The transmission unit 40 is situated in the transition between the first frame section 10 and the second frame section 20. The bicycle frame 2 with the receiving region is designed in such a way that cables extend essentially inside the first frame section 10 and the second frame section 20. Cables that are used to connect the transmission unit 40 are guided directly to the transmission unit 40. No cables are visible from the outside.

The gearshift provided at the handlebars is connected to the transmission unit 40. Cable routing extends in the first frame section 10 and to the receiving region of the transmission unit 40. Further cables, for example from the battery unit 3 to the electric motor 4, extend from the first frame section 10 to the second frame section 20 without ever leaving them. The brake cable is preferably also guided to the rear wheel in this way. Cable routing that is mostly internal is thus achieved, which prevents damage to the cables and thus results in less maintenance effort.

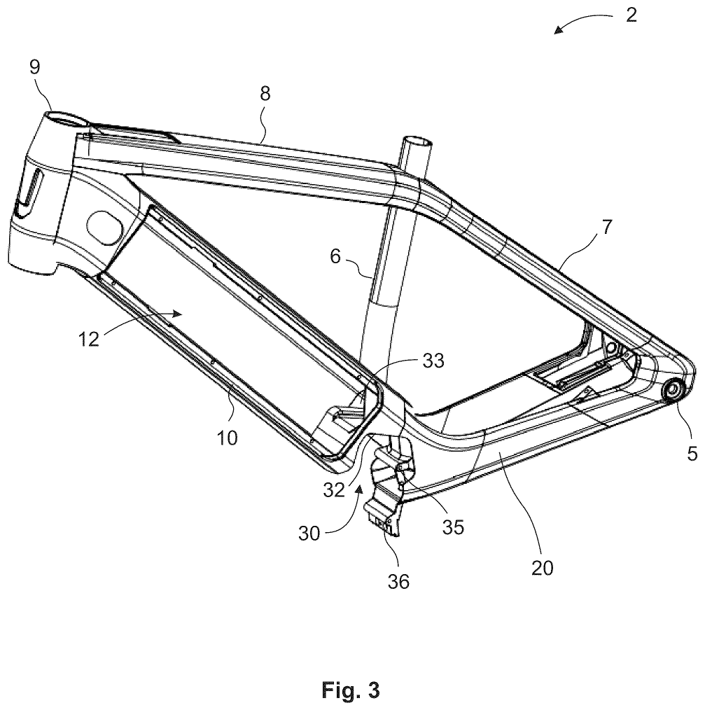

FIG. 3 shows a bicycle frame 2 according to the invention without further accessory parts. In one preferred embodiment, the bicycle frame 2 is made of an aluminum alloy, for example aluminum 6061 (AlMg1SiCu). Better elongation at break behavior may be achieved with this alloy in conjunction with appropriate age hardening (solution annealing). In the event of damage, the tube undergoes only slightly more deformation before it breaks, thus providing a greater safety reserve.

The bicycle frame 2 is preferably produced from a single piece that essentially combines two triangular shapes. The bicycle frame 2 includes a head tube 9, a top tube 8, a seat tube 6, seat tube stays 7, as well as a first frame section 10 and a second frame section 20. The second frame section 20 leads to a rear wheel suspension 5. The first frame section 10 begins at the head tube 9 and extends to the end of the receiving region 30, which at that location has a downwardly leading extension 36.

The first frame section 10 has an interior space 12 for accommodating at least one battery or battery unit. The battery or battery unit is not shown in the illustration. In the first frame section 10 the interior space 12 is covered by a closure cover, which allows a side opening with access to the battery or battery unit.

The enlarged frame cross section in the first frame section 10 allows not only the storage and housing of the battery or battery unit, but also cable routing in the interior.

The bicycle frame 2 also has a receiving region 30 between the first frame section 10 and the second frame section 20 for a transmission unit 40. The seat tube 6 in the upper region is directly connected to the frame section, and thus guarantees stability for the frame 2.

The receiving region 30 includes a feedthrough region 33 that connects the first frame section 10 and the second frame section 20. The feedthrough region 33 has multiple passages that allow good access when the transmission, i.e., the transmission unit 40, is not installed. This simplifies installation and service with regard to accessibility of the cables, which are guided through tubes or channels and/or directly in the first frame section 10 and the second frame section 20. As a result of the receiving region 30 being situated for the most part inside the frame and the transmission being mounted inside the frame, the passages in the installed state of the transmission unit 40 are not visible.

Since the receiving region 30 and/or the feedthrough region 33 are/is not visible, they may be designed in a weight-optimized manner.

The receiving region 30 is at the same time also the receiving unit for a belt tensioner. Since the dimensions of the belt tensioner must be within a certain tolerance as a function of the transmission, it is advantageous that the receiving region 30 accommodates both the transmission unit 40 and the belt tensioner. It is particularly advantageous when the belt tensioner is screwed directly to the transmission unit 40, since the tolerance chain is then even shorter.

At the same time, the stand 13 may also be fastened to the transmission unit 40. This reduces the number of required parts.

The receiving region 30 has an at least semicircular or arched recess 32 on both sides. The transmission unit 40 is installed in this receiving region 30 and is thus integrated into the frame 2. The inner receiving region 30 is adapted to the contour or external shape of the transmission unit 40. At the beginning of the second frame section 20, the receiving region 30 has the downwardly leading extension 36, which serves to accommodate the transmission unit 40 and absorb particular loads. Illustrated in the receiving region 30 is a fastening element 35, also referred to as a mounting element, that is used to fix the transmission unit 40. Further fastening or mounting elements are advantageously provided in or around the receiving region 30 and the extension 36.

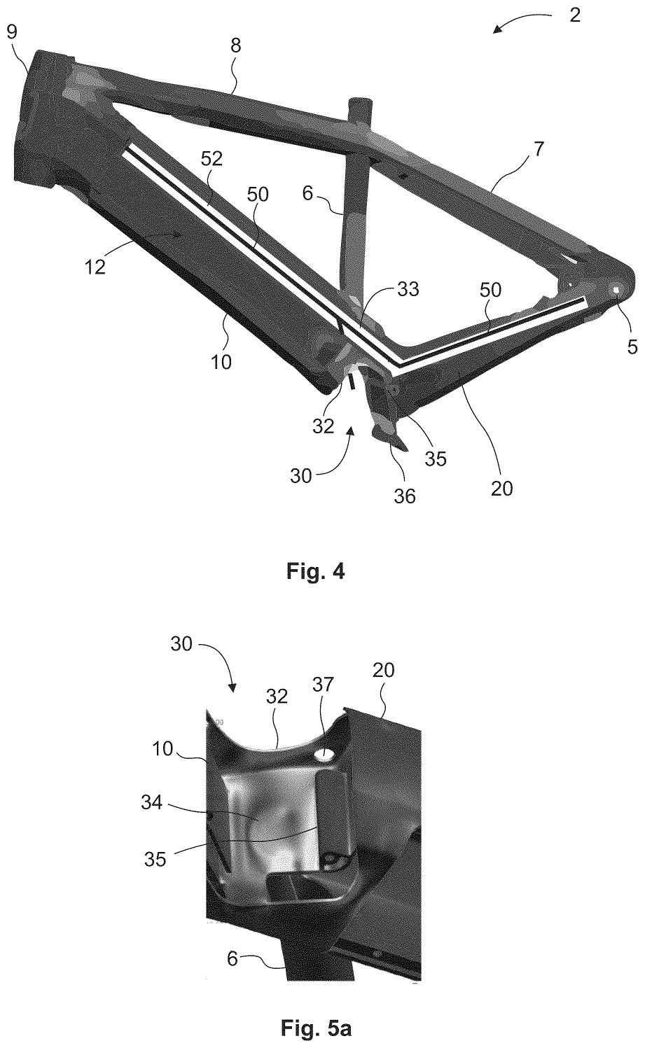

FIG. 4 shows a bicycle frame according to the invention with a schematic illustration of a cable routing region 52.

The bicycle frame 2 once again includes a head tube 9, a top tube 8, a seat tube 6, seat tube stays 7, as well as a first frame section 10 and a second frame section 20. The second frame section 20 leads to a rear wheel suspension 5. The bicycle frame 2 has a receiving region 30 between the first frame section 10 and the second frame section 20 for a transmission unit 40.

The cable routing region 52 is schematically illustrated, and extends from the first frame section 10 to the second frame section 20. The receiving region 30 for the transmission unit 40 is situated where the first frame section 10 and second frame section 20 essentially meet. The cable routing region 52 has a continuous design.

Cables 50 are guided in the cable routing region 52. The cables 50 are, for example, electric cables, a shifter cable, a brake cable, and/or a hydraulic line. It is advantageous that the entire cable routing takes place inside the frame 2. The cables 50 leave the frame 2 only where this is necessary, for example at the rear end of the second frame section 20. The electric cable from the battery unit leaves the interior of the frame and leads to the electric motor 4. The hydraulic line to the rear wheel brake also leaves the interior of the frame only at the rear end of the second frame section 20.

An FEM analysis performed in accordance with existing standards for S-pedelecs having a total weight up to 150 kg demonstrates improved strength of the frame 2. The FEM analysis has verified sufficient strength under a load of 5000 N on the drive belt. The rigidity of the transmission 40 was not taken into account. A further FEM analysis of the frame 2 under a load of 6000 N on the drive belt and a pedal force of 1350 N on the right side has likewise verified sufficient strength. In addition, yet a further FEM analysis of the frame 2 under a double load of 1000 N on each of the pedals has verified the overall behavior of the structure as sufficiently stable.

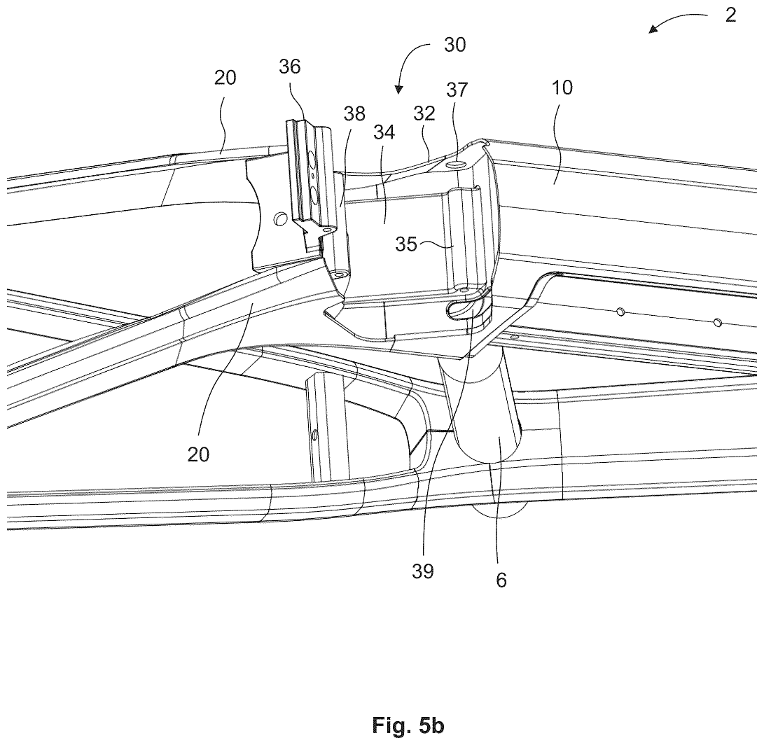

FIG. 5a shows a portion of the receiving region 30 from below, without the extension 36. The concave or semicircular or arched recess 32 is discernible at the sides. The receiving region 30 has a flat surface 34, a so-called base plate, in the interior. Good weldability is thus provided. The base plate is integrated into the frame. When the transmission unit 40 is installed, weld seams are not visible from the outside. In addition, the receiving region 30 has a hole 37 and a fastening element 35 for the transmission unit 40 that is to be installed. The fastening element 35, also referred to as a mounting element 35, may accommodate a bolt or a screw which is laterally guided through the hole 37 and to the fastening element 35. For stability purposes, the fastening element 35 is advantageously welded directly to the base plate. The transmission unit 40, as illustrated in FIG. 7, is installed in the receiving region 30 and is thus integrated into the frame 2. The supplying of the cables to the transmission unit 40 takes place inside the first frame section 10 of the frame 2.

FIG. 5b shows a further illustration of a portion of the receiving region 30 with the extension 36. The extension 36 extends from the second frame section 20. The arched recess 32 is discernible on one side. The receiving region 30 once again has a base plate, i.e., a flat surface 34, in the interior. The base plate is securely and stably integrated into the frame. When the transmission unit 40 is installed, weld seams are not visible from the outside. The receiving region 30 has a hole 37 and a fastening element 35 for the transmission unit 40 that is to be installed. The fastening element 35 or mounting element 35 accommodates a bolt or a screw which is laterally guided through the hole 37 and to the fastening element 35. A further fastening element 38 is situated on the opposite side of the base plate 35. The extension 36 also has yet a further fastening element. The transmission unit 40, as illustrated in FIG. 7, is installed in the receiving region 30 and fixed by means of fastening elements via bolts or screws. The supplying of the cables to the transmission unit 40 takes place inside the first frame section 10 through a cable supply region 39. In addition to cables, other elements may also be guided into the receiving region 30. The cables 50 extend essentially inside the first frame section 10 and the second frame section 20, but only the cables that are used to connect the transmission unit 40 are guided into the receiving region 30. Further cables advantageously do not extend through the receiving region 30, and are thus guided separately. This results in advantages for installation and service.

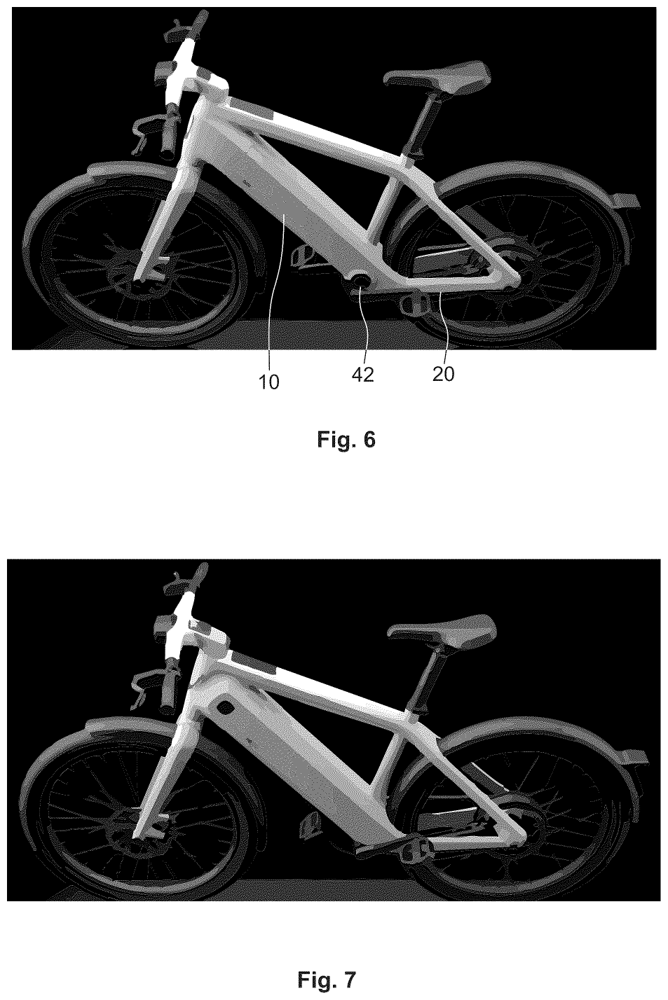

FIG. 6 shows a further side view of an E-bike 1 with a bicycle frame 2 according to the invention, and an integrated bottom bracket transmission unit 40. The transmission unit 40 may be covered with a decorative panel 42. In one particular embodiment, the bicycle frame 2 is designed in such a way that the second frame section 20 directly adjoins the first frame section 10, and the two frame sections merge seamlessly into one another.

FIG. 6 shows a further advantage, namely, that the passage between the first frame section 10 and the second frame section 20 may be made accessible from the outside when the transmission or the transmission unit 40 is uninstalled. Without such “simple” access, it is often very time-consuming to guide lines and cables from the first frame section 10 into the second frame section 20 for installation and service.

FIG. 7 shows yet a further side view of an E-bike 1 with a bicycle frame 2 according to the invention, and an integrated bottom bracket transmission unit 40. In this embodiment a decorative panel is not necessary and thus is not visible, since the transmission unit 40 is completely integrated into the frame 2.

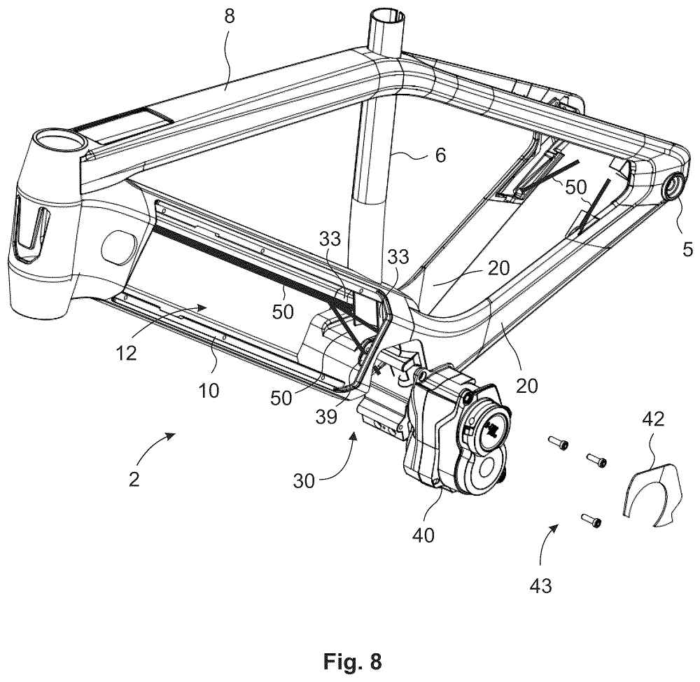

FIG. 8 shows a detailed view of the transmission installation, including the decorative panel 42. The transmission unit 40 is introduced into the receiving region 30, fastened via screw attachments using screws 43, and covered with the decorative panel 42. Cables 50 of the transmission unit 40 are guided inside the frame 2 in the first frame section 10, supplied through the cable supply region 39 to the transmission unit 40, and attached thereto. Further cables 50 that extend to and through the second frame section 20 are guided on both sides through the feedthrough region 33 and to the rear, and leave the second frame section 20 only just in front of the rear wheel receptacle 5 for connection of the electric motor 4 or the brakes (neither of which are illustrated). The transmission unit 40 is easily replaceable since it is fastened with only a few screws. The transmission unit 40 may preferably be removed or replaced by loosening approximately six screws. The frame 2 allows a high level of modularity. The E-bike 1 with the frame 2 is low-maintenance, and due to the ease of replacement of components may be quickly placed in a travel-ready state.

The present invention discloses an E-bike and a frame. It is self-evident that for the person skilled in the art, numerous further embodiments in this field are conceivable based on the exemplary embodiments described by way of example.

### LIST OF REFERENCE NUMERALS

1 E-bike
2 bicycle frame
3 battery unit
4 electric motor
5 rear wheel receptacle or rear wheel suspension
6 seat tube
7 seat tube stays
8 top tube
9 head tube
10 first frame section
12 interior space
13 stand
20 second frame section
30 receiving region
32 recess
33 feedthrough region
34 flat surface
35 fastening element, mounting element
36 extension
37 hole
38 further fastening element
39 cable supply region
40 transmission unit
42 decorative panel
43 screws
50 cable
52 cable routing region

1. A bicycle frame, in particular for an E-bike, comprising:
a first frame section with an interior space for accommodating at least one battery unit;
a second frame section that adjoins the first frame section and extends to a rear wheel receptacle, and
a receiving region, associated with the frame section, for a transmission unit,
wherein the first frame section, the second frame section, and the receiving region are designed such that cables extend essentially inside the first frame section and the second frame section, and essentially only cables that are used to connect the transmission unit are guided into the receiving region.

2. The bicycle frame according to claim 1, wherein the receiving region corresponds to the contour of the transmission unit or has at least one concave recess.

3. The bicycle frame according to claim 1, wherein the receiving region has at least one flat surface in the interior.

4. The bicycle frame according to claim 1, wherein the receiving region includes a fastening element that is welded to the first frame section, to the second frame section, and/or to a seat tube.

5. The bicycle frame according to claim 1, wherein a feedthrough region for guiding the cables extends separately from the receiving region.

6. The bicycle frame according to claim 1, wherein the receiving region for the transmission unit is situated essentially at one end of the first frame section, at the transition to the second frame section.

7. The bicycle frame according to claim 1, wherein the second frame section directly adjoins the first frame section.

8. The bicycle frame according to claim 1, wherein the second frame section has a fork-shaped design.

9. The bicycle frame according to claim 1, wherein the first frame section, the receiving region, and the second frame section merge seamlessly into one another.

10. The bicycle frame according to claim 1, wherein the first frame section, the receiving region, and the second frame section have a cable routing region in the interior.

11. The bicycle frame according to claim 1, wherein the cables comprise at least two or more of the following: an electric cable, a shifter cable, a brake cable, a hydraulic line.

12. An electric bicycle that includes a bicycle frame according to claim 1.
